(19) United States
(12) Patent Application Publication
(10) Pub. No.: US 2025/0216640 A1
(43) Pub. Date: Jul. 3, 2025

(54) DUPLEX CONNECTOR STRUCTURALLY CONFIGURED TO COUPLE WITH ANOTHER DUPLEX CONNECTOR TO ENHANCE INSTALLATION AND CABLE MANAGEMENT

(71) Applicant: BELDEN CANADA ULC, SAINT-LAURENT (CA)

(72) Inventors: Mads FYNBOE, Hoejbjerg (DK); Moise LEVY, Laval (CA); Ana Carolina Marino CRUZ, Pierrefonds (CA)

(73) Assignee: BELDEN CANADA ULC, SAINT-LAURENT, QC (CA)

(21) Appl. No.: 19/004,894

(22) Filed: Dec. 30, 2024

Related U.S. Application Data
(60) Provisional application No. 63/616,503, filed on Dec. 29, 2023.

(51) Int. Cl. G02B 6/44

(52) U.S. Cl. CPC G02B 6/4471

(57) ABSTRACT

A duplex fiber optic connector may have a body portion with a cable holding portion. A connector coupling portion may couple the body portion with a body portion of a second same duplex fiber optic connector to provide a quad fiber optic connector. The cable holding portion may include a first cable holding portion a second cable holding portion that respectively hold first and second fiber optic cables. The first cable holding portion and the second cable holding portion may define a top wall portion of the body portion and a bottom wall portion of the body portion. The connector coupling portion may couple the body portion such that the bottom wall portion faces a bottom wall portion of the second same duplex connector and the second same duplex connector is prevented from being separated from the body portion in a direction away from the bottom wall portion so as to enhance installation and cable management.

### CROSS-REFERENCE TO RELATED APPLICATION

This application claims the benefit of U.S. Provisional Patent Application No. 63/616,503, filed on Dec. 29, 2023, the disclosure of which is hereby incorporated by reference herein in its entirety.

### TECHNICAL FIELD

The present disclosure is directed to a cable management and, more particularly, to a system for retaining multiple cables at predetermined distances with a variety of different clips.

### BACKGROUND

As greater volumes of digital information is generated, transferred, stored, and retrieved, distributed signal networks have increased the number of connections employed in residential, commercial, and industrial sites. The use of wired connections can provide robust signal transmission capabilities, such as speed, security, and reliability, but can have physical size and space requirements that can be inefficient. For instance, signal carrying cables need to be physically installed and correctly connected to devices to utilize the performance capabilities of the cable, and connected devices.

With advancements in technology, maintenance of cable connections, and changes in connected devices, cables may be frequently installed, uninstalled, physically connected, and physically disconnected over time. Such frequent cable manipulation can jeopardize the position and/or accuracy of cable installation and connection. The availability of cable management clips can provide a degree of connection/installation reliability, but may be easily misaligned and/or inadvertently separated from cables, particularly when the cable and/or clip is physically contacted. Hence, there is a continuing goal to optimize cable management and physical cable connections with a system that provides modular clips that can be interconnected to form robust physical support for environments employing multiple cables concurrently.

### SUMMARY

In accordance with various aspects of the disclosure, a duplex fiber optic connector may include a cable holding portion and a connector coupling portion. The cable holding portion may include a first cable engaging portion and a second cable engaging portion disposed parallel to one another and spaced apart from one another to define a first cable receiving portion structurally configured to receive a first fiber optic cable and a first holding portion structurally configured to hold the first fiber optic cable. The cable holding portion may include a third cable engaging portion and a fourth cable engaging portion disposed parallel to one another and spaced apart from one another to define a second cable receiving portion structurally configured to receive a second fiber optic cable and a second holding portion structurally configured to hold the second fiber optic cable. The body portion may include a middle portion between the first cable holding portion and the second cable holding portion. The first cable holding portion may be aligned with the second cable holding portion along a transverse axis of the body portion. The first cable receiving portion and the second cable receiving portion may be disposed at first and second sides, respectively, of the body portion along the transverse axis such that the first cable receiving portion and the second cable receiving portion are structurally configured to receive a fiber optic cable in a direction of the transverse axis. The first cable engaging portion and the third cable engaging portion may be structurally configured to define a top wall portion of the body portion while the second cable engaging portion and the fourth cable engaging portion are structurally configured to define a bottom wall portion of the body portion. The bottom wall portion may be structurally configured to define the connector coupling portion on a surface portion of the bottom wall portion facing away from the top wall portion. The connector coupling portion may be structurally configured to slidingly receive a connector coupling portion of a second same duplex fiber optic connector to form a quad fiber optic connector. The connector coupling portion may include a receiving portion at the second cable engaging portion and a connecting portion at the fourth cable engaging portion. The receiving portion may be structurally configured to be slidingly coupled with a connecting portion of the second connector and the connecting portion may be structurally configured to be slidingly coupled with a receiving portion of the second connector such that the second connector may be prevented from being separated from the body portion in a direction away from the bottom wall portion so as to enhance installation and cable management.

The duplex connector, in some embodiments, may configure the connecting portion as a dovetail projection and the receiving portion as a dovetail opening structurally configured to match the dovetail projection. A quad fiber optic connector may be provided with a duplex connector and a second same duplex connector with the coupling portion of the duplex connector being slidingly coupled with the coupling portion of the second same duplex connector. Embodiments of a quad connector may arrange a center of the first holding portion of the duplex connector and a center of the second holding portion of the second same duplex connector spaced apart by a minimum pitch distance while a center of the second holding portion of the duplex connector and a center of the first holding portion of the second same duplex connector are spaced apart by the minimum pitch distance, such as 7 mm.

In accordance with various aspects of the disclosure, a duplex fiber optic connector, may include a cable holding portion and a connector coupling portion. The cable holding portion may have a first cable engaging portion and a second cable engaging portion disposed parallel to one another and spaced apart from one another to define a first holding portion structurally configured to hold a first fiber optic cable. The cable holding portion may have a third cable engaging portion and a fourth cable engaging portion disposed parallel to one another and spaced apart from one another to define a second holding portion structurally configured to hold a second fiber optic cable. The first cable engaging portion and the third cable engaging portion may define a top wall portion of the body portion while the second cable engaging portion and the fourth cable engaging portion are structurally configured to define a bottom wall portion of the body portion. The bottom wall portion may define the connector coupling portion on a surface portion of the bottom wall portion facing away from the top wall portion. The connector coupling portion may slidingly receive a connector coupling portion of a second same duplex fiber optic connector to form a quad fiber optic connector. The connector coupling portion may have a receiving portion at the second cable engaging portion and a connecting portion at the fourth cable engaging portion. The receiving portion may be slidingly coupled with a connecting portion of the second connector and the connecting portion may be slidingly coupled with a receiving portion of the second connector such that the second connector is prevented from being separated from the body portion in a direction away from the bottom wall portion so as to enhance installation and cable management.

Some embodiments of the duplex connector may arrange the connecting portion as a dovetail projection and the receiving portion as a dovetail opening structurally configured to match the dovetail projection. A quad fiber optic connector may be provided with a duplex connector and a second same duplex connector with the coupling portion of the duplex connector slidingly coupled with the coupling portion of the second same duplex connector. A quad connector may have a center of the first holding portion of the duplex connector and a center of the second holding portion of the second same duplex connector spaced apart by a minimum pitch distance while a center of the second holding portion of the duplex connector and a center of the first holding portion of the second same duplex connector are spaced apart by the minimum pitch distance, such as 7 mm.

In accordance with various aspects of the disclosure, a duplex fiber optic connector, may include a cable holding portion and a connector coupling portion configured to couple the body portion with a body portion of a second same duplex fiber optic connector to provide a quad fiber optic connector. The cable holding portion may have a first cable holding that holds a first fiber optic cable and a second cable holding portion that holds a second fiber optic cable. The first cable holding portion and the second cable holding portion may define a top wall portion of the body portion and a bottom wall portion of the body portion. The connector coupling portion may couple the body portion with a body portion of a second same duplex connector such that the bottom wall portion faces a bottom wall portion of the second same duplex connector and the second same duplex connector is prevented from being separated from the body portion in a direction away from the bottom wall portion so as to enhance installation and cable management.

A duplex connector, in some embodiments, may have the bottom wall portion defining the connector coupling portion on a surface portion of the bottom wall portion facing away from the top wall portion while the connector coupling portion may slidingly receive a connector coupling portion of a second same duplex fiber optic connector to form a quad fiber optic connector and the connector coupling portion has a receiving portion at the first cable holding portion and a connecting portion at the second cable holding portion. A duplex connector may arrange the connecting portion as a dovetail projection and the receiving portion as a dovetail opening structurally configured to match the dovetail projection. The duplex connector, along with a second same duplex connector, may form a quad fiber optic connector with the coupling portion of the duplex connector slidingly coupled with the coupling portion of the second same duplex connector. A quad connector may have a center of the first holding portion of the duplex connector and a center of the second holding portion of the second same duplex connector spaced apart by a minimum pitch distance while a center of the second holding portion of the duplex connector and a center of the first holding portion of the second same duplex connector are spaced apart by the minimum pitch distance, such as 7 mm.

A duplex connector, in other embodiments, may arrange the connector coupling portion to include a first coupling portion that attaches to the first cable holding portion and a second holding portion of a second same duplex connector and a second coupling portion that attaches to the second cable holding portion and a first holding portion of the second same duplex connector. The duplex connector, along with a second same duplex connector, may form a quad fiber optic connector with the coupling portion of the duplex connector slidingly coupled with the coupling portion of the second same duplex connector. A quad connector may have a center of the first holding portion of the duplex connector and a center of the second holding portion of the second same duplex connector spaced apart by a minimum pitch distance while a center of the second holding portion of the duplex connector and a center of the first holding portion of the second same duplex connector are spaced apart by the minimum pitch distance, such as 7 mm.

### BRIEF DESCRIPTION OF THE DRAWINGS

Further advantages and features of the present disclosure will become apparent from the following description and the accompanying drawings, to which reference is made.

FIG. 1 is a line representation of portions of a cable environment in which assorted embodiments of a cable pulling system may be practiced.

FIG. 2 is a line representation of portions of a cable assembly that may be employed in the environment of FIG. 1.

FIG. 3 is a line representation of portions of a cable clip system that may be utilized in the cable assembly of FIG. 2 and the cable environment of FIG. 1.

FIG. 4 is a perspective view of a an exemplary duplex fiber optic connector in accordance with various embodiments of this disclosure.

FIG. 5 is a perspective view an exemplary duplex connector assembly including the duplex fiber optic connector of FIG. 4.

FIG. 6 is a perspective view of another exemplary duplex fiber optic connector in accordance with various embodiments of this disclosure.

FIG. 7 is a perspective view of portions of an exemplary duplex connector assembly including the duplex fiber optic connector of FIG. 6.

FIG. 8 is a perspective view of portions of an exemplary duplex connector assembly including the duplex fiber optic connector of FIG. 6.

FIG. 9 is a perspective view of portions of an exemplary duplex connector assembly including another exemplary duplex fiber optic connector in accordance with various embodiments of this disclosure.

FIG. 10 is a perspective view of portions of an exemplary duplex connector assembly including the duplex fiber optic connector of FIG. 9.

### DETAILED DESCRIPTION

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The proliferation of data and digital information has emphasized the integrity of distributed networks. Imprecise cable connections may jeopardize the integrity of one or more signal pathways of a distributed network. Imprecise cable connections may further increase the time needed for cable management, installation, and manipulation over time. As such, various embodiments are directed to a cable clip system that provides modularity to allow efficient integration into a variety of different cabling configurations and environments.

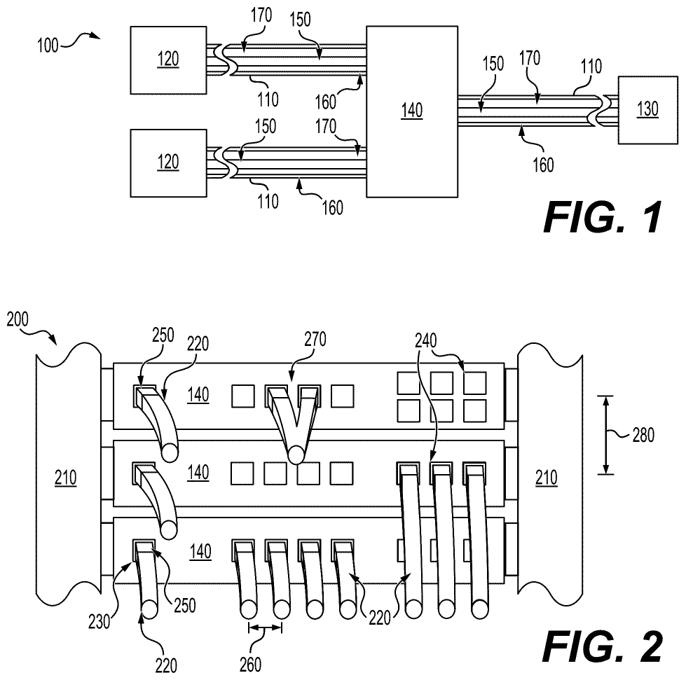

FIG. 1 displays a block representation of portions of a cable environment 100 in which assorted embodiments of the present disclosure can be practiced. Any number, and type, of cable 110 can provide at least one stable signal pathway between a source 120 to a destination 130. While a cable environment 100 may include a single source 120 connected to a single destination 130 via a single, continuously extending cable 110, such configuration is not required as one or more interconnects 140, such as a switch, server, connector, splitter, or other device, can provide one or more stable signal pathways with numerous separate cables 110, as generally shown. The ability to use one or more interconnects 140 allows for the formation, operation, and maintenance of a distributed network where separate, and potentially different, sources 120 interact with separate, and potentially different, destinations 130.

A cable 110 can house one or more signal conductors 150, such as an electrically conducting wire or optical conduit, that provide two-way communication between at least one source 120 and at least one destination 130. A cable conductor 150 can be positioned within one or more protective jackets 160 that provide environmental and mechanical protection to the conductor 150. A cladding material 170 may further be encapsulated by a jacket 160 to protect the integrity of the conductor 150 and enhance signal carrying performance.

FIG. 2 illustrates a line representation of portions of a cable assembly 200 in which multiple interconnects 140 are physically mounted in accordance with various embodiments of the present disclosure to provide a distributed network. The cable assembly 200 has a rigid rack 210 that provides secure placement of multiple separate interconnects, such as a patch panel, switch, or server, to supply input cables 110 as well as at least one output cable 220. An interconnect 140 may be any size, orientation, and capability that are utilized independently, collectively, and/or concurrently. It is noted that two separate interconnects 140 that are each positioned in the rack 210 may match, or be dissimilar.

As shown in FIG. 2, the physical position and orientation of the respective interconnects 140 are uniform and matching throughout the rack 210. Such interconnect 140 configuration positions various input ports 230 and output ports 240 in a single plane facing away from the rack 210. It is contemplated that one or more of the interconnects 140 can be orientated differently so that cables 110/220, and ports 230/240 are directed towards the rack 210, which would be a rotation of 90 degrees compared to the embodiment shown in FIG. 2.

The arrangement of the assorted ports 230/240 allows for increased density, and size utilization within the rack 210, while allowing sufficient cooling capabilities over time. However, the heightened density of interconnects 140 within the rack 210 can pose installation and cable management difficulties. For instance, placement of the various interconnect ports 230/240 can result in overlapping cables or obstructions that inhibit efficient physical access to a cable connector 250. As a result, cables 110/220 may be incorrectly installed into an interconnect port 230/240 or movement of an adjacent cable 110/220 may disrupt the physical integrity, and connection, of one or more cable connectors 250.

Another specific, but non-limiting, example inadvertently disrupts the pitch 260 of adjacent cables arranged in a duplex configuration. The pitch 260 can be characterized as a linear distance between the center of adjacent cables 110/220. A change from a desired pitch 260 can inhibit, or prevent, signal carrying capabilities of a cable 110/220, particularly a cable configuration utilizing two or more cables 110/220 for signal carrying operation. It is noted that a single cable 270 can provide multiple conductors that concurrently connect to ports 230/240, which may also be susceptible to changes in pitch 260 due to encountered external force. Risk of inadvertent changes in pitch 260 may additionally be present when cables 110/220 are connected, or otherwise physically attached, across a vertical distance 280 between different interconnects 140, which can be characterized as vertical pitch.

As shown in FIG. 2, mounting the interconnects 140 in the rack can provide easy access to the respective interconnects ports 230/240 individually, but can pose efficiency, organization, management, and alteration difficulties over time when the rack 210 has multiple interconnects 140 occupied with various cables 110/220. For instance, input cables 110 can be difficult to discern from output cables 220 just as cables 110/220 connecting to one interconnect 140 can be difficult to discern from cables 110/220 connecting to other interconnects 140. In addition to organizational cabling issues, the threat of inadvertent physical force acting on a cable connector 250 may pose a risk of unwanted alteration of the operation of one or more port connections when handling and/or manipulating other cables 110/220 connected to the respective interconnects.

In an effort to mitigate the risk of inadvertent pitch alteration while aiding in the efficiency and accuracy of cable 110/220 installation concurrently into more than one port 230/240, a clip may physically retain more than one cable 110/220. For cable configurations that involve multiple port connections for full performance, such as duplex or quadplex arrangements, a clip can provide cable organization while maintaining assorted pitch distances 260/280, which align the cable connectors 250 with the destination interconnect ports 230/240.

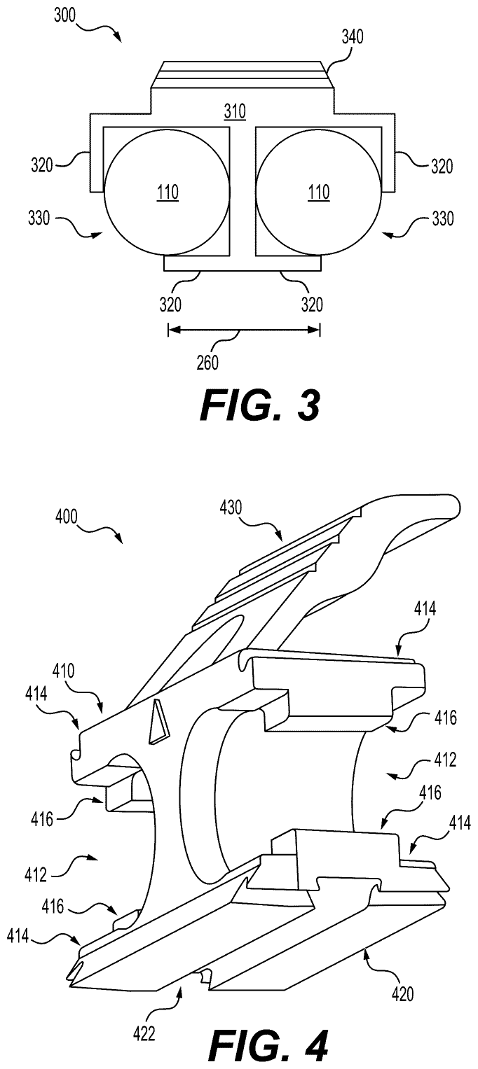

FIG. 3 is a line representation of a cable clip system 300 that may be employed in the cable assembly 200 of FIG. 1 and the cable environment 100 of FIG. 1. The clip system 300 utilizes a body portion 310 that may be constructed of one or more materials, components, or pieces that present retention portions 320 that physically engage portions of a cable 110. It is noted that while an input cable 110 is illustrated in FIG. 3, such configuration is not limiting and the clip body 310 can contact and retain an output cable 220 or a cable connector 250.

The number, size, and shape of the retention portions 320 may be arranged to provide one or more openings 330 that allow for ingress and egress of a cable 110. It is contemplated, but not required, that one or more of the retention portions 320 are configured to temporarily bend, or otherwise deform, to allow a cable 110 to be installed, or removed, from a retention cavity defined within the retention portions 320. Some embodiments of the retention portions 320 apply constant force onto a cable 110, when installed as shown in FIG. 3.

The clip system 300 can employ one or more tab portions 340 cantilevered from the body portion 310 to provide articulable movement within a predetermined range. A tab portion 340 can extend from the body portion 310 to selectively engage aspects of a connector 250 or interconnect port 230/240 to facilitate cable 110 installation, or removal into an interconnect 140. In embodiments that do not utilize a tab portion 340, individual physical engagement of connector 250 would be necessary for cable 110 installation or removal. Hence, embodiments of the clip system 300 can provide a single mechanism for physically selecting multiple cable connectors 250.

Through the utilization of one or more clip bodies 310 in a cable assembly 200, cable pitch 260 may be more reliably maintained than unsupported, individual cables 110. However, some clip bodies 310 may be limited with respect to providing physical stability and organization for more than a pair of cables 110, such as cables 110 organized into a quadplex configuration with different polarities. Accordingly, various embodiments of a cable clip system 300 provide modularity to allow selective attachment of multiple clip bodies 310 to provide expandable arrangements that maintain cable 110 organization and consistent cable pitches 260/280 along both horizontal and vertical planes, as generally shown in FIG. 2.

FIGS. 4-10 respectively convey assorted aspects of a duplex connector assembly 400 that can employ matching, or dissimilar, body portions 410, or clip bodies, to provide efficient expansion of a duplex cable configuration into a quad cable configuration that provides secure cable pitches 260/280 along orthogonal planes. The perspective view of FIG. 4 illustrates a body portion 410 that presents a cable holding portion 412 configured to securely contact and hold portions of a cable 110/220 and/or cable connector 250. The body portion 410 includes cable engagement portions 414 (also referred to as cable retention portions or retention arm portions) that define aspects of the respective cable holding portions 412, The cable engagement portions 414 may include retention protrusions 416, as shown.

The view of FIG. 4 displays how the body portion 410, for example, a unitary cable clip body, may be arranged to define separate cable regions that can respectively hold a cable during installation, removal, and operation of a connection with interconnect ports. As illustrated, the cable holding portion 412 includes a first cable holding portion and a second cable holding portion aligned with one another along a transverse axis of the body portion. The body portion 410 includes a middle portion between the first cable holding portion and the second cable holding portion.

The cable holding portion 412 may include a first cable engaging portion 414 and a second cable engaging portion 414 disposed parallel to one another and spaced apart from one another to define the first cable holding portion that is structurally configured to hold a first fiber optic cable, and which may be accessible via a first cable receiving portion, or opening, structurally configured to receive the first fiber optic cable. The cable holding portion may include a third cable engaging portion 414 and a fourth cable engaging portion 414 disposed parallel to one another and spaced apart from one another to define the second cable holding portion configured to hold a second fiber optic cable, which may be accessible via a second cable receiving portion, or opening, structurally configured to receive a second fiber optic cable.

The cable holding portion 412 may be accessible in a transverse direction via a cable receiving portion or cable opening. A cable retaining portion 416, for example, a pair of cable retention protrusions, may be rigid or flexible to allow for efficient installation of a cable 110 into a cable holding portion 412 and retention of the cable in the cable holding portion 412, while also permitting removal of the cable from the cable holding portion 412.

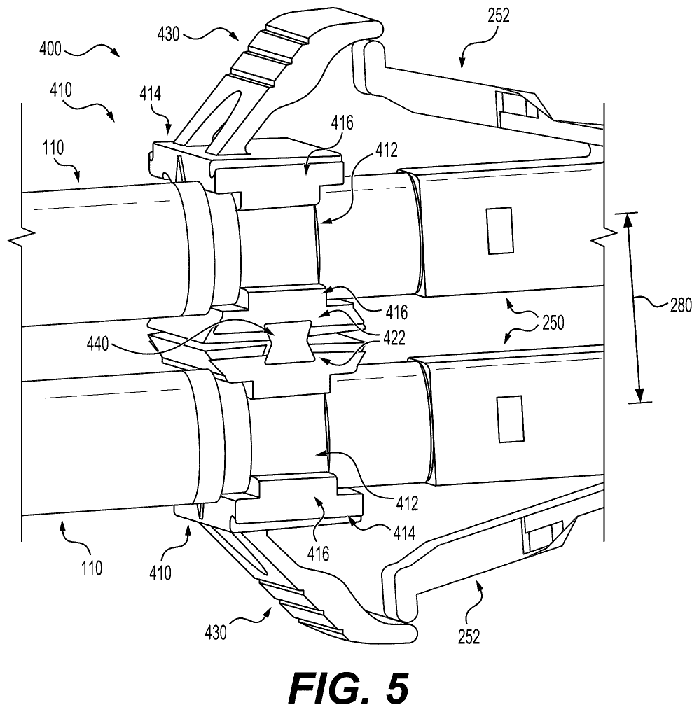

The shape and size of the respective arm portions 414 and retention protrusions 416 are not limited to the configuration shown in FIG. 4, but can be arranged to be symmetric about the body's midplane, which provides transverse symmetry. The clip body 410 has a connection portion 420 on a first side and a tab portion 430 on an opposite second side. The tab portion 430 may have any size and shape that facilitates the efficient, concurrent physical interaction with activation levers 252 of cable connectors 250 to allow simultaneous connector 250 selection, as generally shown in FIG. 5. As a result of the use of a single tab portion 430 to engage multiple separate connector levers 252, applied forces can be proportioned more efficiently than if individual levers 252 were physically selected, which reduces the risk of inadvertent pitch variations during cable 110 installation into ports of an interconnect, as shown in FIG. 2.

The connection portion 420 is configured to continuously extend from one transverse side of the clip body 410 to the opposite transverse side to present at least one connection feature 422 that allows the secure attachment of another clip body 410, as generally illustrated in FIG. 5. While not required or limiting, a first body 410 may securely attach to a second body 410 via one or more key portions 440 that at least partially occupy a connection feature 422. In the specific example shown in FIG. 5 where a vertical pitch 280 is secured by attaching matching, but inverted, clip bodies 410, a solid, rigid piece of material, such as a polymer, metal, ceramic, or rubber, is configured to occupy connection features 422 of separate clip bodies 410 to securely join the bodies 410. In some aspects, a center of the first holding portion of the first body 410 and a center of the second holding portion of the second body 410 are spaced apart by a minimum pitch distance and a center of the second holding portion of the first body 410 and a center of the first holding portion of the second body 410 are spaced apart by the minimum pitch distance. For example, the minimum pitch distance may be 7 mm.

With the single rigid key portion 440 arranged as a separate component from either clip body 410, a technician may selectively attach one clip body 410 with another clip body 410, as shown in FIG. 5. Such selectively attach clip bodies 410 provides modularity that corresponds with the ability to attach, and detach, various different clip bodies 410 without altering the configuration, or operation, of either clip body 410. To clarify, modularity of the clip system 400 can be characterized as an ability to selectively attach separate clip bodies 410 together without altering either clip body 410.

As a result of such modularity, a wide range of clip system 400 configurations can be achieved while providing a secure, consistent, and reliable vertical pitch 280. For instance, clip bodies 410 with different horizontal pitches 260, different cable diameter openings 412, and/or different cable retaining protrusions 416 may be securely attached via one or more key portions 440 for any amount of time. The separate structure of the key portion 440 relative to the respective clip bodies 410 allows for clip bodies 410 to be selectively employed alone or in an attached arrangement. However, the key portion 440 is not required to be a physically separate component from a clip body 410.

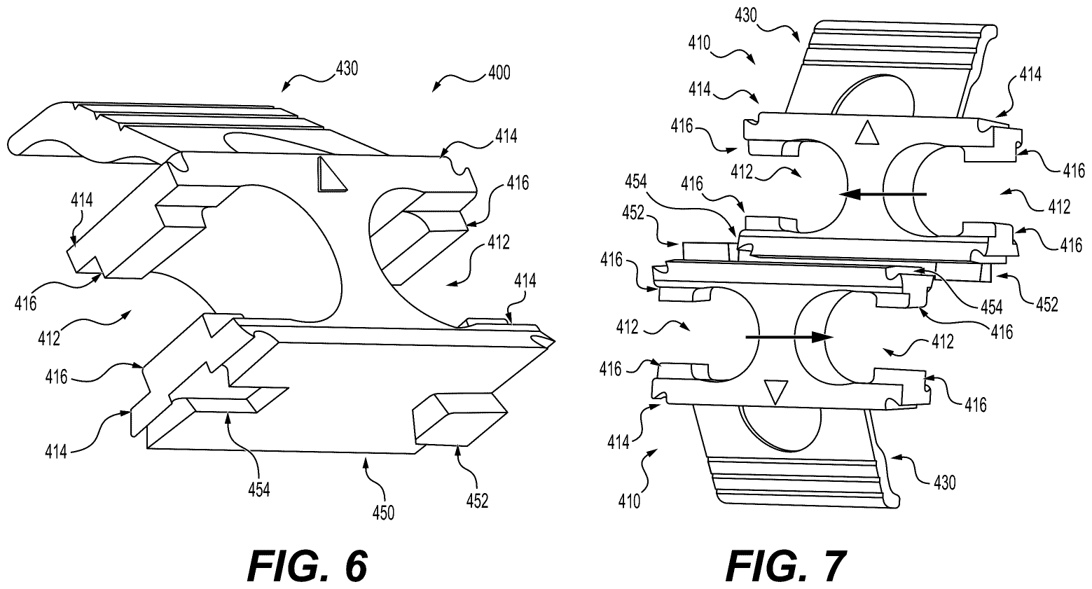

FIGS. 6-8 illustrate embodiments of the duplex connector assembly 400 that employs a key portion 450 incorporated into the connection portion 420 of a body portion 410. FIG. 6 is a perspective view of a single body portion 410 with key portion 450 configured with a connection protrusion 452 and a connection recess 454. While not required or limiting, the combination of the protrusion 452 and recess 454 allow for secure physical engagement with another body portion 410, as shown in FIG. 7. However, it is noted that the connection protrusion 452 extends beyond a planar bottom surface of the body portion 410, which may pose storage and/or utilization difficulties in some situations.

The shape, size, and number of protrusions 452 and recesses 454 is not limited and may be different in body portions 410 that are physically attached to concurrently provide a consistent horizontal pitch 260 and vertical pitch 280 for four separate cable connectors 250. In the non-limiting embodiment shown in FIGS. 6-8, a single connection protrusion 452 is configured to mate with a connection recess 454 of an attached body portion 410. Such physical attachment may arrange the respective protrusion 452 and recess 454 with matching, or dissimilar, shapes and sizes. That is, a connection recess 454 may, in some embodiments, have an inverse shape and matching size as a connection protrusion 452. Other embodiments may arrange a connection recess 454 with a depth, cross-sectional shape, and/or length that does not match the connection protrusion 452 of a physically attached body portion 410.

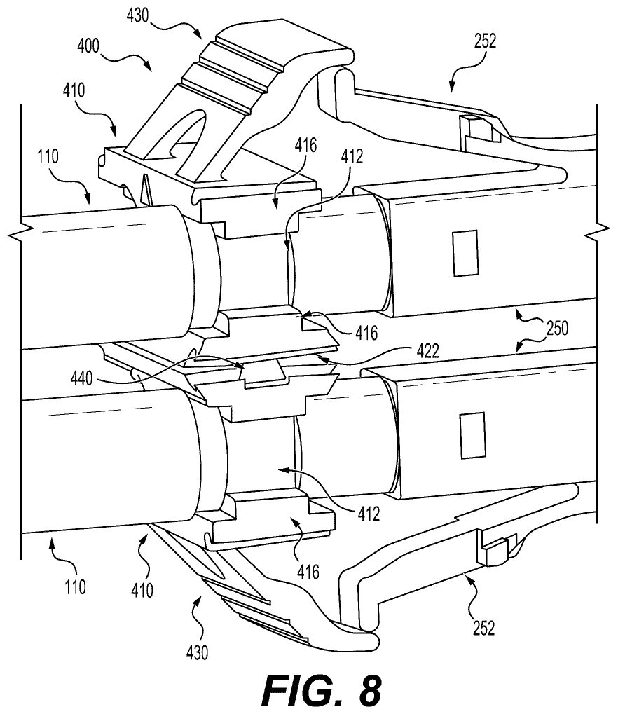

As illustrated in FIG. 7 by solid arrows, utilization of the key portions 450 of separate body portions 410 may involve aligning the respective protrusions 452 and recesses 454 before sliding one body portion 410 relative to the other body portion 410. Once a connection protrusion 452 occupies at least a portion of a connection recess 454, the previously separate body portions 410 are joined into a single, unitary component, as shown in FIG. 8, that allows for the efficient installation, and removal, of multiple cable connectors 250 into separate ports 230/240 of one or more interconnects 140. Yet, the act of sliding one body portion 410 relative to another body portion 410 can prove difficult at times, particularly once one or more cable holding portions 412 are occupied by a cable 110 or connector 250.

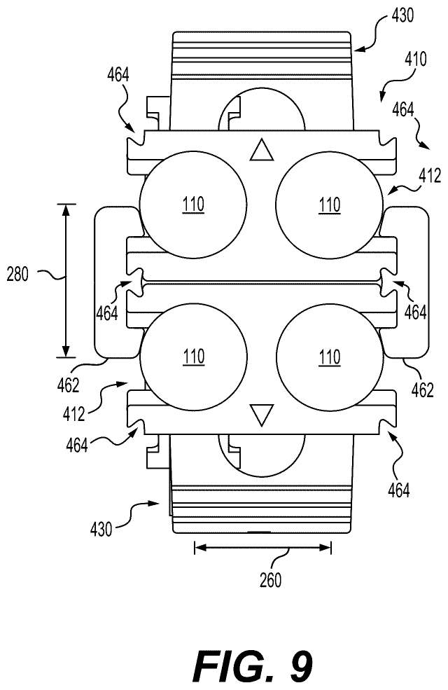

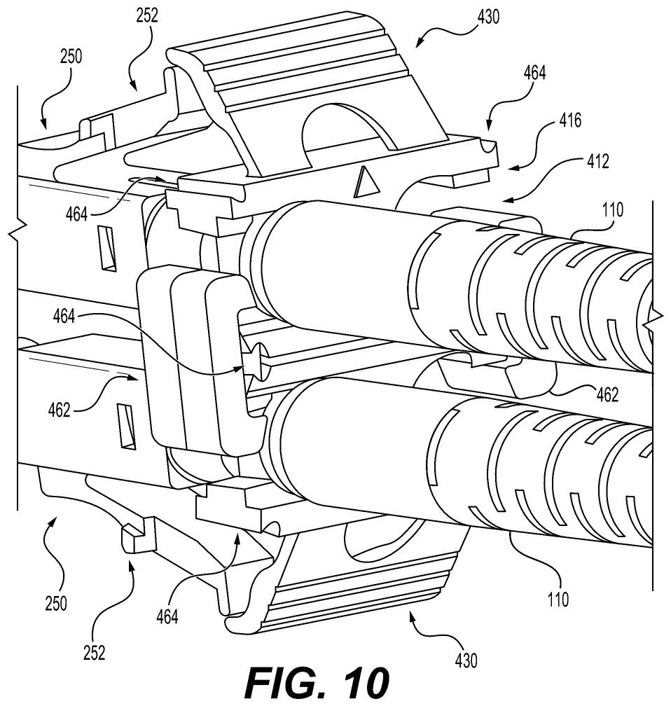

FIGS. 9 and 10 respectively illustrate aspects of a duplex connector assembly 400 that employs a pair of key portions 460 to mate a pair of body portions 410. FIG. 9 is a front view of the connector assembly 400 that conveys how a key portion 460 joins body portions 410 with a pair of separate key features 462. While not limiting or required, one or more key features 462 may secure one body portion 410 to another body portion 410 to provide reliable and secure horizontal pitch 260 and vertical pitch 280 for four cables 110 by continuously wrapping around connection slots 464 that are defined by recesses in each cable engagement portion 414 of each body portion 410.

When compared to the key portions 440/450 of FIGS. 4-8, the key portion 460 may employ multiple separate key features 462 that slide into the respective connection slots 464 from a transverse direction that is parallel to the respective cables 110, which is orthogonal to the key portion 440 that slides into the connection feature 422 along a longitudinal direction/axis of the respective clip bodies. Such orientation of the key features 462 may provide more efficient installation than the key portions 440/450 due to the multiple separate components as well as the ability to slide the features 462 into the respective slots 464 from a different direction relative to the body portions 410. That is, the use of key features 462 to secure the body portion 410 together can provide different installation and/or access behavior that is conducive to different installation environments than the key portions 440/450 of FIGS. 4-8.

In some embodiments, the respective key features 462 can occupy aspects of the cable holding portion 412, once installed into a connection slot 464, which may physically support and retain a cable 110 in the body portion 410 along with the retention protrusions 416. Hence, the respective key features 462 may be configured to concurrently retain body portions 410 relative to one another while physically contacting and retaining at least one cable 110 within a cable holding portion 412.

It is contemplated that one or more of the key features 462 can engage the respective body portions 410, and potentially one or more connection slots 464, in manners different than the sliding configuration shown in FIGS. 9 and 10. One non-limiting example utilizes the key portion 450 of FIGS. 6-8 in combination with one or more key features 462 to increase the physical retention of the respective cables 110 over time. In other words, any number, type, and location of key portion/feature can be utilized to maintain securely form a quad cable 110 configuration with reliable horizontal pitches 260/280 between four cables 110 retained in a pair of clip bodies 410 with matching physical arrangements. Some embodiments of a key feature 462 may structurally configure a key portion or feature to push, twist, or bend onto a connection slot 464 to physically retain and support the collective assembly 400 comprising a pair of body portions 410, as shown in FIGS. 4-10.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A duplex fiber optic connector configured to couple with a second same duplex fiber optic connector to enhance installation and cable management, comprising:
a body portion structurally configured to include a cable holding portion and a connector coupling portion;
wherein the cable holding portion includes a first cable engaging portion and a second cable engaging portion disposed parallel to one another and spaced apart from one another to define a first cable receiving portion structurally configured to receive a first fiber optic cable and a first holding portion structurally configured to hold the first fiber optic cable;
wherein the cable holding portion includes a third cable engaging portion and a fourth cable engaging portion disposed parallel to one another and spaced apart from one another to define a second cable receiving portion structurally configured to receive a second fiber optic cable and a second holding portion structurally configured to hold the second fiber optic cable;
wherein the body portion includes a middle portion between the first cable holding portion and the second cable holding portion;
wherein the first cable holding portion is aligned with the second cable holding portion along a transverse axis of the body portion;
wherein the first cable receiving portion and the second cable receiving portion are disposed at first and second sides, respectively, of the body portion along the transverse axis such that the first cable receiving portion and the second cable receiving portion are structurally configured to receive a fiber optic cable in a direction of the transverse axis;
wherein the first cable engaging portion and the third cable engaging portion are structurally configured to define a top wall portion of the body portion, and wherein the second cable engaging portion and the fourth cable engaging portion are structurally configured to define a bottom wall portion of the body portion;
wherein the bottom wall portion is structurally configured to define the connector coupling portion on a surface portion of the bottom wall portion facing away from the top wall portion;
wherein the connector coupling portion is structurally configured to slidingly receive a connector coupling portion of a second same duplex fiber optic connector to form a quad fiber optic connector;
wherein the connector coupling portion includes a receiving portion at the second cable engaging portion and a connecting portion at the fourth cable engaging portion;
wherein the receiving portion is structurally configured to be slidingly coupled with a connecting portion of the second connector and the connecting portion is structurally configured to be slidingly coupled with a receiving portion of the second connector such that the second connector is prevented from being separated from the body portion in a direction away from the bottom wall portion so as to enhance installation and cable management.

2. The duplex connector of claim 1, wherein the connecting portion is a dovetail projection and the receiving portion is a dovetail opening structurally configured to match the dovetail projection.

3. A quad fiber optic connector, comprising:
the duplex connector of claim 1;
a second same duplex connector; and
wherein the coupling portion of the duplex connector is slidingly coupled with the coupling portion of the second same duplex connector.

4. The quad connector of claim 3, wherein a center of the first holding portion of the duplex connector and a center of the second holding portion of the second same duplex connector are spaced apart by a minimum pitch distance; and
wherein a center of the second holding portion of the duplex connector and a center of the first holding portion of the second same duplex connector are spaced apart by the minimum pitch distance.

5. The quad connector of claim 4, wherein the minimum pitch distance is 7 mm.

6. A duplex fiber optic connector configured to couple with a second same duplex fiber optic connector to enhance installation and cable management, comprising:
a body portion structurally configured to include a cable holding portion and a connector coupling portion;
wherein the cable holding portion includes a first cable engaging portion and a second cable engaging portion disposed parallel to one another and spaced apart from one another to define a first holding portion structurally configured to hold a first fiber optic cable;
wherein the cable holding portion includes a third cable engaging portion and a fourth cable engaging portion disposed parallel to one another and spaced apart from one another to define a second holding portion structurally configured to hold a second fiber optic cable;
wherein the first cable engaging portion and the third cable engaging portion are structurally configured to define a top wall portion of the body portion, and wherein the second cable engaging portion and the fourth cable engaging portion are structurally configured to define a bottom wall portion of the body portion;
wherein the bottom wall portion is structurally configured to define the connector coupling portion on a surface portion of the bottom wall portion facing away from the top wall portion;
wherein the connector coupling portion is structurally configured to slidingly receive a connector coupling portion of a second same duplex fiber optic connector to form a quad fiber optic connector;
wherein the connector coupling portion includes a receiving portion at the second cable engaging portion and a connecting portion at the fourth cable engaging portion;
wherein the receiving portion is structurally configured to be slidingly coupled with a connecting portion of the second connector and the connecting portion is structurally configured to be slidingly coupled with a receiving portion of the second connector such that the second connector is prevented from being separated from the body portion in a direction away from the bottom wall portion so as to enhance installation and cable management.

7. The duplex connector of claim 6, wherein the connecting portion is a dovetail projection and the receiving portion is a dovetail opening structurally configured to match the dovetail projection.

8. A quad fiber optic connector, comprising:
the duplex connector of claim 6;
a second same duplex connector; and
wherein the coupling portion of the duplex connector is slidingly coupled with the coupling portion of the second same duplex connector.

9. The quad connector of claim 8, wherein a center of the first holding portion of the duplex connector and a center of the second holding portion of the second same duplex connector are spaced apart by a minimum pitch distance; and
wherein a center of the second holding portion of the duplex connector and a center of the first holding portion of the second same duplex connector are spaced apart by the minimum pitch distance.

10. The quad connector of claim 9, wherein the minimum pitch distance is 7 mm.

11. A duplex fiber optic connector configured to couple with a second same duplex fiber optic connector to enhance installation and cable management, comprising:
a body portion structurally configured to include a cable holding portion;
a connector coupling portion structurally configured to couple the body portion with a body portion of a second same duplex fiber optic connector to provide a quad fiber optic connector;
wherein the cable holding portion includes a first cable holding portion structurally configured to hold a first fiber optic cable and a second cable holding portion structurally configured to hold a second fiber optic cable;
wherein the first cable holding portion and the second cable holding portion are structurally configured to define a top wall portion of the body portion and a bottom wall portion of the body portion;
wherein the connector coupling portion is structurally configured to couple the body portion with a body portion of a second same duplex connector such that the bottom wall portion faces a bottom wall portion of the second same duplex connector and the second same duplex connector is prevented from being separated from the body portion in a direction away from the bottom wall portion so as to enhance installation and cable management.

12. The duplex connector of claim 11, wherein the bottom wall portion is structurally configured to define the connector coupling portion on a surface portion of the bottom wall portion facing away from the top wall portion;
wherein the connector coupling portion is structurally configured to slidingly receive a connector coupling portion of a second same duplex fiber optic connector to form a quad fiber optic connector;
wherein the connector coupling portion includes a receiving portion at the first cable holding portion and a connecting portion at the second cable holding portion.

13. The duplex connector of claim 12, wherein the connecting portion is a dovetail projection and the receiving portion is a dovetail opening structurally configured to match the dovetail projection.

14. A quad fiber optic connector, comprising:
the duplex connector of claim 12;
a second same duplex connector; and
wherein the coupling portion of the duplex connector is slidingly coupled with the coupling portion of the second same duplex connector.

15. The quad connector of claim 14, wherein a center of the first holding portion of the duplex connector and a center of the second holding portion of the second same duplex connector are spaced apart by a minimum pitch distance; and
wherein a center of the second holding portion of the duplex connector and a center of the first holding portion of the second same duplex connector are spaced apart by the minimum pitch distance.

16. The quad connector of claim 15, wherein the minimum pitch distance is 7 mm.

17. The duplex connector of claim 11, wherein the connector coupling portion includes a first coupling portion configured to attach to the first cable holding portion and a second holding portion of a second same duplex connector and a second coupling portion configured to attach to the second cable holding portion and a first holding portion of the second same duplex connector.

18. A quad fiber optic connector, comprising:
the duplex connector of claim 17;
a second same duplex connector; and
wherein the coupling portion of the duplex connector is slidingly coupled with the coupling portion of the second same duplex connector.

19. The quad connector of claim 18, wherein a center of the first holding portion of the duplex connector and a center of the second holding portion of the second same duplex connector are spaced apart by a minimum pitch distance; and
wherein a center of the second holding portion of the duplex connector and a center of the first holding portion of the second same duplex connector are spaced apart by the minimum pitch distance.

20. The quad connector of claim 19, wherein the minimum pitch distance is 7 mm.
